(19) United States
(12) Patent Application Publication
(10) Pub. No.: US 2012/0139827 A1
(43) Pub. Date: Jun. 7, 2012

(54) METHOD AND APPARATUS FOR INTERACTING WITH PROJECTED DISPLAYS USING SHADOWS

(76) Inventors: KEVIN A. LI, Chatham, NJ (US); Lisa Gail Cowan, San Diego, CA (US)

(21) Appl. No.: 12/959,231

(22) Filed: Dec. 2, 2010

(51) Int. Cl. G06F 3/01

(52) U.S. Cl. 345/156

(57) ABSTRACT

A method, computer readable medium and apparatus for interacting with a projected image using a shadow are disclosed. For example, the method projects an image of a processing device to create the projected image, and detects a shadow on the projected image. The method interprets the shadow as a display formatting manipulation command and sends the display formatting manipulation command to an application of the processing device to manipulate a display format of the projected image.

### BACKGROUND

Small displays, e.g., on mobile devices, make it difficult to share displayed information with collocated individuals. Pico projectors allow mobile device users to share visual information on their display with those around them. However, current projectors, e.g., for mobile devices, only support interaction via the mobile device's interface. As a result, users must look at the mobile device display to interact with the mobile device's buttons or touch screen. This approach divides the user's attention between the mobile device and the projected display.

This context switching distracts presenters and viewers from ongoing conversations and other social interactions taking place around the projected display. Additionally, other collocated users may find it difficult to interpret what the presenter is doing as he interacts with the mobile device. Furthermore, the other collocated individuals have no way of interacting with the mobile device or the projected display themselves.

### SUMMARY

In one embodiment, the present disclosure teaches a method, computer readable medium and apparatus for interacting with a projected image using a shadow. For example, the method projects an image of a processing device to create the projected image, and detects a shadow on the projected image. The method interprets the shadow as a display formatting manipulation command and sends the display formatting manipulation command to an application of the processing device to manipulate a display format of the projected image.

### BRIEF DESCRIPTION OF THE DRAWINGS

The teaching of the present disclosure can be readily understood by considering the following detailed description in conjunction with the accompanying drawings, in which:

FIG. 1 illustrates one example of a system for interacting with projected displays;

FIG. 2 illustrates one example of a shadow that performs a pointing gesture;

FIG. 3 illustrates one example of a shadow that performs a panning gesture;

FIGS. 4A and 4B illustrate one example of a shadow that performs a first type of zooming gesture;

FIGS. 5A and 5B illustrate one example of a shadow that performs a second type of zooming gesture;

FIG. 6 illustrate a high level flow chart of a method for interacting with projected displays;

FIG. 7 illustrates a more detailed flow chart of a method for interacting with projected displays;

FIG. 8 illustrates one embodiment using two systems for interacting with projected displays; and

FIG. 9 illustrates a high-level block diagram of a general-purpose computer suitable for use in performing the functions described herein.

To facilitate understanding, identical reference numerals have been used, where possible, to designate identical elements that are common to the figures.

### DETAILED DESCRIPTION

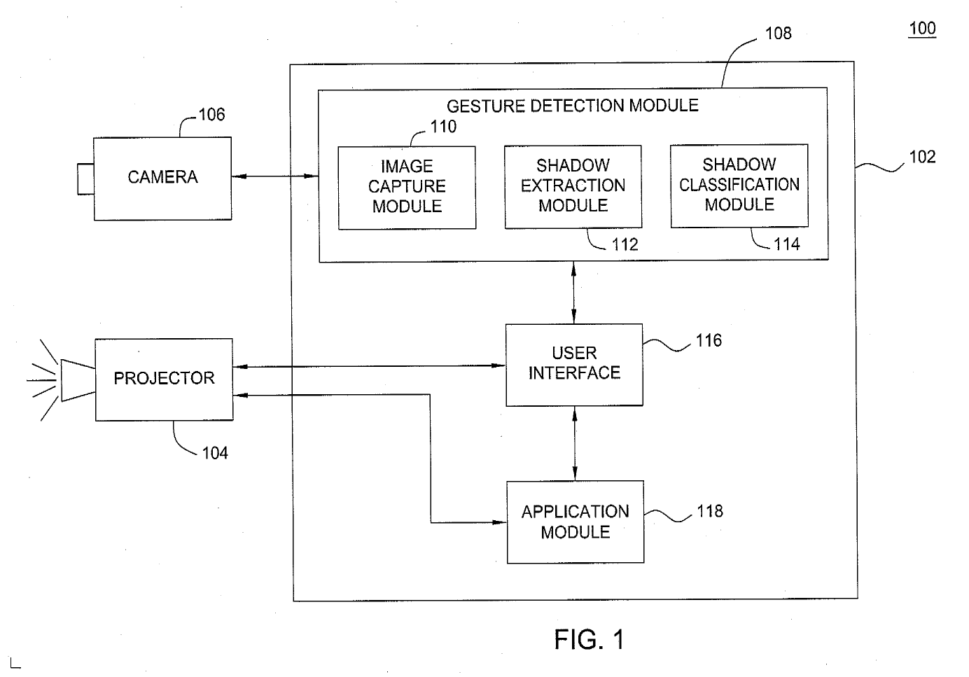

The present disclosure broadly discloses a method, computer readable medium and an apparatus for interacting with projected displays with shadows. FIG. 1 is a block diagram depicting one example of a system 100 for interacting with projected displays, e.g., mobile projected displays, related to the current disclosure. In one embodiment, the system 100 includes a processing device, e.g., a mobile device, 102, a projector 104 and a camera 106. It should be noted that although processing device 102 is discussed below in the context of a mobile device, the present disclosure is not so limited. In other words, a non-mobile device performing the functions as discussed below can be within one embodiment of the present disclosure.

In one embodiment, the mobile device 102 may be any type of mobile device having a display such as, for example, a mobile phone, a personal digital assistant (PDA), a smart phone, a cellular phone, a net book, a lap top computer and the like. In one embodiment, the projector 104 is a mobile device projector such as, for example, a laser pico projector. However, any projectors capable of interfacing with the mobile device 102 can be used in accordance with the present disclosure. The camera 106 may be either integrated into the mobile device 102 or be an external camera connected to the mobile device 102.

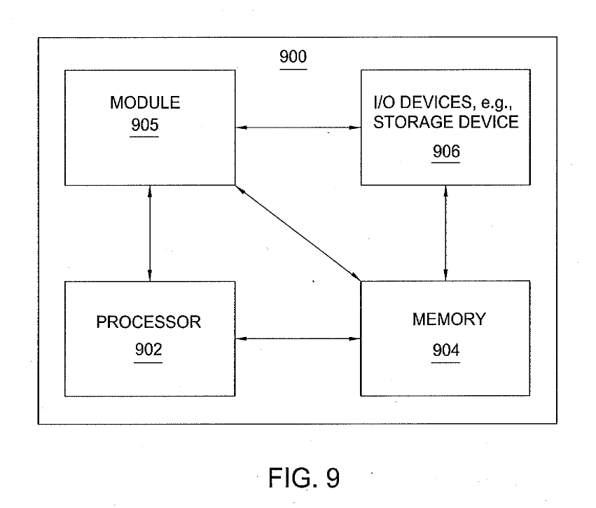

In one embodiment, the mobile device 102 may include various components of a general purpose computer as illustrated in FIG. 9. In addition, the mobile device 102 includes a gesture detection module 108, a user interface 116 and an application module 118. The gesture detection module 108 may comprise additional modules or sub-modules such as, for example, an image capture module 110, a shadow extraction module 112, and a shadow classification module 114. At a high level, the image capture module 110 processes an image captured by the camera 106, the shadow extraction module 112 identifies a shadow in the captured image and the shadow classification module 114 classifies what type of gesture the shadow is performing and interprets the gesture to a display formatting manipulation command for the application module 118. Although a plurality of separate modules is illustrated, the present disclosure is not so limited. Namely, one or more modules can be used to perform the functions as disclosed below.

In other words, embodiments of the present disclosure pertain to methods of using shadows to change the format of the projected display or projected image that would otherwise need to be performed using the user interface 116 of the mobile device. A projected display broadly comprises a projected image such as a chart, a picture, a diagram, a table, a map, a graph, a screen capture, and the like, where a plurality of projected displays comprises a plurality of projected images. As such, projected display and projected image are used interchangeably. In one embodiment, formatting may be defined to include changing a size of the entire projected display (e.g., zooming in and out), moving which part of an image to be displayed (e.g., panning up, down, left or right), highlighting a specific area of the projected display (e.g., pointing to a part of the display to cause a pop-up window to appear), changing an orientation of the projected display (e.g., rotating the projected display), and the like. These processes and functions are discussed in further detail below.

In other words, the shadows are being used for applications that typically do not expect a shadow to be present. Rather, the applications typically are waiting for some command to be entered via the user interface 116. However, the present disclosure provides the ability to provide the commands that the application uses to operate the projected display via shadows rather than directly entering the commands via the user interface 116. For example, a map may have an associated pan left command by pressing a left arrow on the user interface 116. In one embodiment, the pressing of the left arrow on the user interface 116 may be substituted by a shadow gesture on the projected display. That is, the shadow gesture may be used as a substitute for conveying the one or more commands to the application that is generating the projected display instead of using the user interface 116.

It should be noted that the shadows are not being used to interact with the projected display as done with video games. For example, in video games, the games may be programmed to specifically expect shadows to appear in parts of the video game. The video games are programmed with shadows in mind. That is, the video game does not expect some command to be entered via the user interface of the mobile device, but rather, expects an input via a shadow. Said another way, there may be no command via a user interface that correlates to a shadow moving their arms up to bounce a ball of the projected image. In other words, in video games, the shadows are not a substitute for commands that would otherwise be available via the user interface, but instead is part of the expected input to operate the video game itself, i.e., without the shadow input, the purpose of the game software cannot be achieved.

As a result, the shadows in video games are only used to move various objects within the display such as a ball, driving a car, moving a character and the like. Said another way, the displayed content is actually being altered by the shadow, e.g., the position of the displayed ball, the position and action of the displayed character, the position and action of the displayed object.

However, the overall format of the projected display itself cannot be changed using the shadows. For example, the shadows are not used to zoom into a particular part of the projected image, pan the projected image left and right, rotate the projected image and the like. Thus, it should be clear to the reader that display formatting manipulation commands generated by the shadows in the present disclosure are not equivalent to interaction of a particular object on a projected image using shadows as done in video games.

In one embodiment, the application module 118 may execute an application on the mobile device 102 that is displayed. For example, the application may be a map application, a photo viewing application and the like. The user interface 116 provides an interface for a user to navigate the application run by the application module 118. For example, the user interface may include various buttons, knobs, joysticks or a touch screen. For example, if a map application is being run, the user interface 116 allows the user to move the map, zoom in and out of the map, point to various locations on the map and so forth.

In operation, the system 100 creates a projected image via the projector 104 onto a screen or a wall. The projected image is an enlarged image of the image on the display of the mobile device 102. However, if several people are collocated and viewing the projected image together, it is difficult to manipulate the display format of the projected image. Typically, only one user would be able to manipulate the projected image. The user would need to manipulate the display format of the projected image via the user interface 116 on the mobile device 102. This can become very distracting to the other collocated individuals as their attention must be diverted from the screen to the mobile device and/or the image is temporarily moved or shaken as the user interacts with the user interface 116 on the mobile device 102 to manipulate the projected image.

However, the present disclosure utilizes shadows on the projected image to manipulate the display format of the projected image. As a result, any one of the collocated individuals may manipulate the display format of the projected image without diverting their attention away from the projected image. For example, by placing an object in front of the projector 104 (e.g., a user's hand, a stylus pen, and the like), a shadow may be projected onto the projected image. The shadow may be captured by the camera 106. It should be noted that the projector 104 should be placed relative to the camera 106 such that when the object is placed in front of the projector 104 to create the shadow, the object would not block the camera 106 or prohibit the camera 106 from capturing the shadow and the projected image.

In one embodiment, the image is processed by the image capture module 110, the shadow is extracted by the shadow extraction module 112 and the shadow is classified by the shadow classification module 114. For example, if the user were to move an object (e.g., their hand or a stylus pen) from left to right, thereby creating a shadow on the projected image that moves from left to right, the gesture detection module 108 would interpret this shadow movement as a gesture that is performing a panning command. The gesture detection module 108 would then send the panning command to the application module 118. As a result, the image created by the application module 118 would be panned from left to right. Accordingly, the projected image would also be panned from left to right.

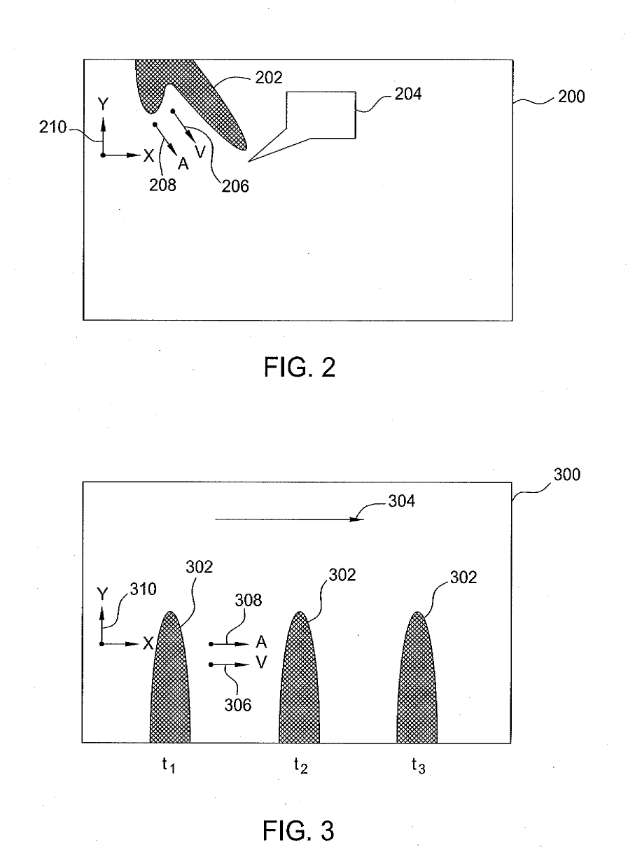

FIGS. 2-5B illustrate various examples of shadow movements and gestures that may be detected and interpreted as a display formatting manipulation command. FIGS. 2-5B are only examples and not intended to be limiting. It should be noted that other gestures and movements may be used and are within the scope of the present disclosure.

FIG. 2 illustrates one example of a shadow that performs a pointing gesture. A projected image 200 may be displayed by the projector 104. Notably, the projected image 200 is an image of an application that is running on and being displayed by the mobile device 102.

In one embodiment, a user places an object in front of the projector 104 to create a shadow 202. Various parameters of the shadow 202 may be tracked such as one or more velocity vectors 206, one or more acceleration vectors 208, one or more position vectors 210 or a shape of the shadow. The various parameters may be continuously tracked over a sliding window of a predetermined amount of time. In other words, various parameters of the shadow 202 are tracked to determine, for example, if the shadow is moving, where the shadow is moving, how fast the shadow is moving and whether the shadow's shape is changing.

In one embodiment, the pointing gesture may be detected based upon a shape of the shadow and the position vectors 210. For example, points on the convex hull of the shadow that are separated by defects can be estimated as a location of a fingertip. If the shadow has this particular type of shape and the fingertip (e.g., the deepest defect) is stable for a predefined period of time, then the gesture is interpreted to be a pointing command.

In one embodiment, stable may be defined as where the position vectors 210 do not change more than a predetermined amount for the predefined period of time. For example, if the pointing shape of the shadow is detected and the shadow does not move more than two inches in any direction for five seconds, then the gesture is interpreted as being a pointing command.

Accordingly, the pointing command may be sent to the application running on the mobile device 102 and an associated action may be activated. For example, executing a pointing command may have an information box 204 appear where the shadow is pointing to. The information box 204 may include information about a location such as, for example, an address, a telephone number, step-by-step directions to the location and the like, if the application is a map application.

FIG. 3 illustrates one example of a shadow that performs a panning gesture. A projected image 300 may be displayed by the projected 104. Notably, the projected image 300 is an image of an application that is running on and being displayed by the mobile device 102.

Similar to FIG. 2, a user places his hand in front of the projector 104 to create a shadow 302 and various parameters of the shadow 302 are tracked. For example, one or more velocity vectors 306, one or more acceleration vectors 308, one or more position vectors 310 or a shape of the shadow may be tracked.

In one embodiment, a panning gesture may be detected based upon the position vectors 310, the velocity vectors 306 and the acceleration vectors 308. FIG. 3 illustrates the shadow 302 moving from left to right across the projected image 300 in three different instances of time t₁ to t₃. The parameters of a centroid of the shadow 302 are analyzed for the panning gesture. If the position vectors 310 of the centroid change and the average velocity of the velocity vectors 306 of the centroid is greater than a predetermined threshold (e.g., the average velocity is greater than 10 inches per second) for a predefined period of time (e.g., for 5 seconds), then the gesture is interpreted as being a panning command in a direction of the velocity vectors 306. For example, if the velocity vectors 306 are moving left to right, the direction of the panning command would be left to right. The velocity vectors 306 may move in any direction, e.g., top to bottom, bottom to top, right to left, diagonally in any direction in between and the like.

In addition, the speed of the panning command may be determined by the average acceleration of the acceleration vectors 308 measured for the predefined period of time or the average velocity of the velocity vectors 306. For example, if the average acceleration or velocity is high, then the projected image may be panned very quickly. Alternatively, if the average acceleration or velocity is low, then the projected image may be panned very slowly.

Accordingly, the panning command from left to right may be sent to the application running on the mobile device 102 and an associated action may be activated. For example, executing a panning command from left to right may cause the projected image 300 (e.g., a map or photos) to move from left to right at a speed proportional to the average acceleration or velocity measured for the shadow 302.

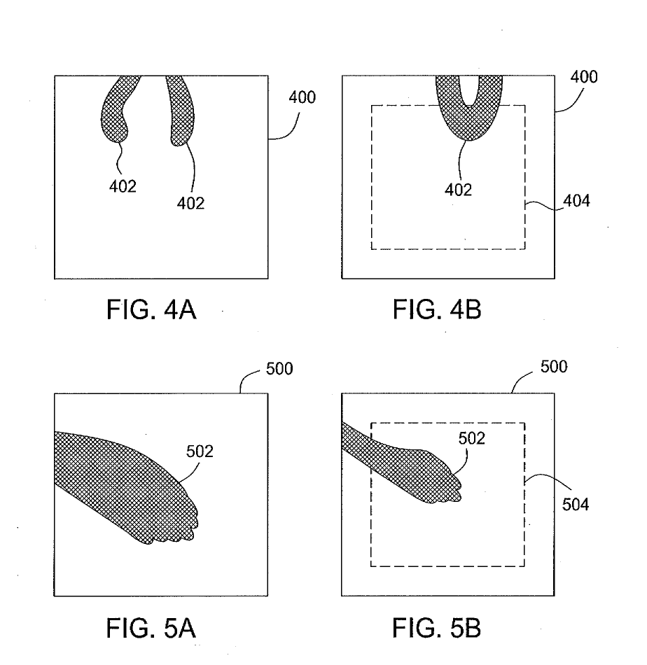

FIGS. 4A-4B and 5A-5B illustrate two different types of shadows that perform a zooming command. With respect to FIG. 4A, a projected image 400 may be displayed by the projector 104. Notably, the projected image 400 is an image of an application that is running on and being displayed by the mobile device 102.

Similar to FIG. 2, a user places an object in front of the projector 104 to create a shadow 402 and various parameters of the shadow 402 are tracked. In one embodiment, a zooming gesture may be detected based upon a change in shape of the shadow 402. For example, shapes that look like fingertips are detected. This may be done by looking for a particular shape of the shadow as discussed above with reference to FIG. 2. That is, points on the convex hull that are separated by defects are estimated as a fingertip. However, for a zooming gesture, two shadows that look like fingertips are detected.

Subsequently, as shown in FIG. 4B, the shadows 402 of two or more fingertips are “pinched” together such that only a single shadow 402 appears. In other words, the fingertips are brought together such that the two shadows 402 overlap into a single shadow 402. If such a movement of the shadow 402 is detected within a predefined time period (e.g., 2 seconds) then the gesture may be interpreted as a “zoom in” command.

Similarly, a “zoom out” command may be issued in the reverse direction. That is, the single shadow 402 would be separated into two or more different shadows 402 that look like two fingertips. For example, the different shadows 402 may be a separation of two fingers or a spreading of multiple fingers.

In either case, the zooming command may be sent to the application running on the mobile device 102 and an associated action may be activated. For example, executing a “zoom in” command may cause the projected image 400 (e.g., a map or photos) to zoom in as illustrated by dashed lines 404.

Alternatively, the zooming gesture may be performed by moving the shadow towards the projector 104 or away from the projector 104, as illustrated by FIGS. 5A and 5B. For example, a user places an object in front of the projector 104 to create a shadow 502 and various parameters of the shadow 502 are tracked. In one embodiment, a zooming gesture may be detected based upon a change in size of the shadow 502 within a predefined time period (e.g., 2 seconds).

FIG. 5A illustrates an initial size of the shadow 502 on a projected image 500. Subsequently, the hand is moved away from the projector 104. In other words, the object is pushing the projected image away from the viewer. FIG. 5B illustrates how the size of the shadow 502 becomes smaller and changes within a predefined time period. If such movement is detected, then the gesture may be interpreted as a “zoom in” command.

Similarly, a “zoom out” command may be issued in the reverse direction. That is, the size of the shadow 502 would become larger as the object is moved closer to the projector 104.

In either case, the zooming command may be sent to the application running on the mobile device 102 and an associated action may be activated. For example, executing a “zoom in” command may cause the projected image 500 (e.g., a map or photos) to zoom in as illustrated by dashed lines 504.

It should be noted that additional gestures and display formatting manipulation commands may be used. For example, a rotating command can be detected by detecting a rotating gesture of a shadow. The rotating command may cause the projected image to rotate clockwise or counter-clockwise. Another command could include an area select command by detecting two “L” shaped shadows moving away from one another to select a box created by the estimated area of the two “Ls”. Yet another command could be an erase or delete command by detecting a shadow quickly moving left to right repeatedly in an “erasing” type motion, e.g., a shaking motion and the like.

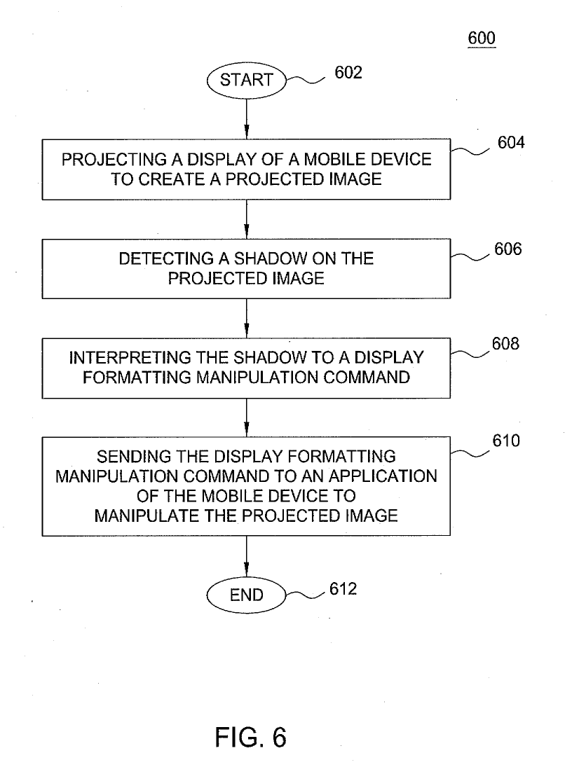

FIG. 6 illustrates a high level flowchart of a method 600 for interacting with projected displays, e.g., mobile projected displays from a mobile device. In one embodiment, the method 600 may be implemented by the mobile device 102 or a general purpose computer having a processor, a memory and input/output devices as discussed below with reference to FIG. 9.

The method 600 begins at step 602 and proceeds to step 604. At step 604, the method projects a display of a mobile device to create a projected image. For example, an image (e.g., a map or a photo) created by an application running on the mobile device may be projected onto a screen or wall to create the projected image.

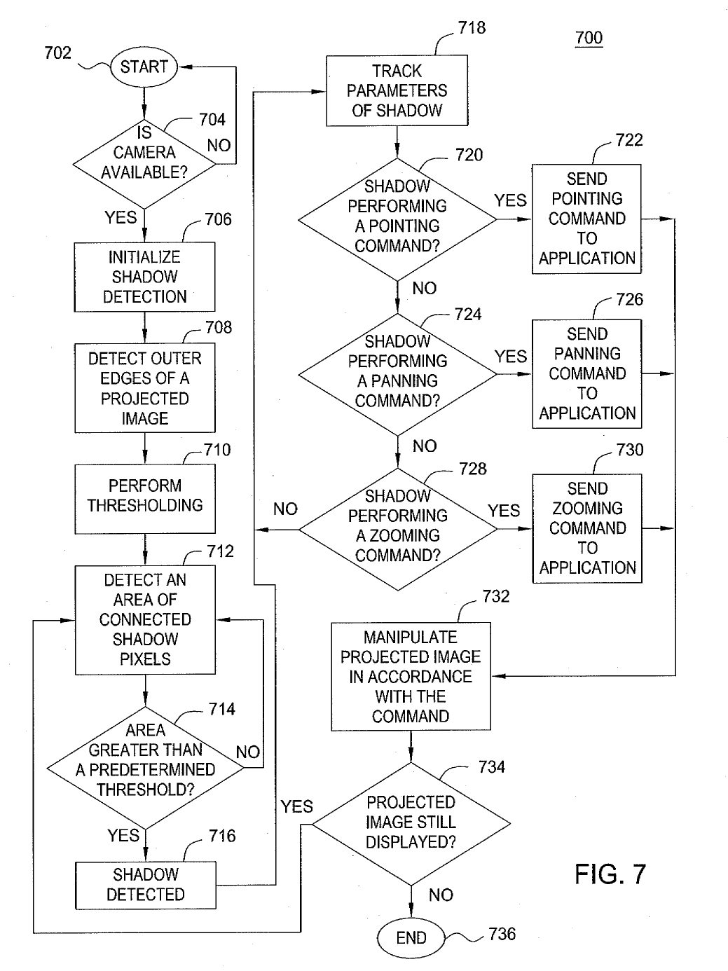

At step 606, the method 600 detects a shadow on the projected image. For example, a camera may be used to capture an image and the captured image may be processed by a gesture detection module 108, as discussed above. Shadow detection may include multiple steps such as initializing the projected image for shadow detection and performing a pixel by pixel analysis relative to the background of the projected image to detect the shadow. These steps are discussed in further detail below with respect to FIG. 7.

At step 608, the method 600 interprets the shadow to be a display formatting manipulation command. As discussed above with respect to FIGS. 2-5B, various parameters of the shadow may be tracked such that the change in shape or movement of the shadow may be interpreted as a display formatting manipulation command.

At step 610, the method 600 sends the display formatting manipulation command to an application of the mobile device to manipulate the projected image. For example, if the shadow was performing a panning gesture that was interpreted as performing a panning command, then the panning command would be sent to the application of the mobile device. Accordingly, the mobile device would pan the image, e.g., left to right. Consequently, the projected image would also then be panned from left to right. In other words, the projected image may be manipulated by any one of the collocated individuals using shadows without looking away from the projected image and without using the user interface 116 of the mobile device 102. The method 600 ends at step 612.

FIG. 7 illustrates a detailed flowchart of a method 700 for interacting with a projected display, e.g., a mobile projected display provided by a mobile device. In one embodiment, the method 700 may be implemented by the mobile device 102 or a general purpose computer having a processor, a memory and input/output devices as discussed below with reference to FIG. 9.

The method 700 begins at step 702 and proceeds to step 704. At step 704, the method 700 determines if a camera is available. If a camera is not available, then the method 700 goes back to step 702 to re-start until a camera is available. If a camera is available, the method 700 proceeds to step 706.

At step 706, the method 700 initializes shadow detection for a projected image. Steps 708 and 710 may be part of the initialization process as well. At step 708, the method 700 detects outer edges of the projected image. For example, the outer edges of the projected image may represent the boundaries from which the system 100 is supposed to try and detect a shadow.

At step 710, the method 700 performs thresholding. For example, a grayscale range (e.g., minimum and maximum values) of a surface (i.e., the background) that the projected image is projected onto is calculated. If a pixel has a grayscale value above a predetermined minimum threshold and the pixel has a grayscale value below the predetermined maximum threshold, then the pixel is determined to be a shadow pixel. In other words, if the pixel has a grayscale value that is similar to the grayscale value of the surface within a predetermined range, then the pixel is determined to be a shadow pixel.

At step 712, the method 700 detects an area of connected shadow pixels. For example, several connected shadow pixels form a shadow on the projected image.

At step 714, the method 700 determines if an area of the connected shadow pixels is greater than a predetermined threshold. For example, to avoid false positive detection of shadows caused by noise or inadvertent dark spots in the projected image, the method 700 only attempts to monitor shadows of a certain size (e.g., an area of 16 square inches or larger). As a result, a small shadow created by an insect flying across the projected image or dust particles would not be considered a shadow. Rather, in one embodiment only areas of connected shadow pixels similar to the size of a human fist or hand would be considered a shadow.

At step 714, if the area is not greater than the predetermined threshold, then the method 700 loops back to step 712. However, if the area is greater than the predetermined threshold, then the method 700 proceeds to step 716 where a shadow is detected.

At step 718, the method 700 tracks parameters of the shadow. As discussed above, various parameters such as velocity vectors, acceleration vectors, position vectors or a size of the shadow may be tracked. The various parameters may be tracked continuously over a sliding window of a predetermined period of time. For example, the parameters may be tracked continuously over five second windows and the like.

Based upon the tracked parameters of the shadow, the method 700 may determine if the shadow is attempting to perform a gesture that should be interpreted as a display formatting manipulation command.

At step 720, the method determines if the shadow is performing a pointing command. The process for determining whether the shadow is performing a pointing command is discussed above with respect to FIG. 2. If the shadow is performing a pointing command, the method 700 proceeds to step 722, where the method 700 sends a pointing command to the application.

If the shadow is not performing a pointing command, the method 700 proceeds to step 724 where the method 700 determines if the shadow is performing a panning command. The process for determining whether the shadow is performing a panning command is discussed above with respect to FIG. 3. If the shadow is performing a panning command, the method 700 proceeds to step 726, where the method 700 sends a panning command to the application.

if the shadow is not performing a panning command, the method 700 proceeds to step 728 where the method 700 determines if the shadow is performing a zooming command. The process for determining whether the shadow is performing a zooming command is discussed above with respect to FIGS. 4A-4B and 5A-5B. If the shadow is performing a zooming command, the method 700 proceeds to step 730, where the method 700 sends a zooming command to the application. In one embodiment, it should be noted that the steps 720, 724 and 728 may be performed simultaneously. If the shadow is not performing a zooming command, the method 700 loops back to step 718 where the method 700 continues to track parameters of the shadow.

At step 732, the method 700 manipulates the projected image in accordance with the display formatting manipulation command. For example, if the display formatting manipulation command was a pointing command, the application may cause an information box to appear on the projected image. If the display formatting manipulation command was a panning command, the application may cause the projected image to pan in the appropriate direction. If the display formatting manipulation command was a zooming command, the application may cause the projected image to zoom in or zoom out in accordance with the zooming command.

At step 734, the method 700 determines if the projected image is still displayed. In other words, the method 700 is looking to see if the projector is still on and the projected image is still being displayed. If the answer to step 734 is yes, the method 700 loops back to step 712, where the method 700 attempts to detect another shadow by detecting an area of connected shadow pixels.

However, if the answer to step 734 is no, then the projected image is no longer displayed. For example, the projector may be turned off and the projected image may no longer be needed. If the answer to step 734 is no, the method 700 proceeds to step 736 and ends.

It should be noted that although not explicitly specified, one or more steps of the methods described herein may include a storing, displaying and/or outputting step as required for a particular application. In other words, any data, records, fields, and/or intermediate results discussed in the methods can be stored, displayed, and/or outputted to another device as required for a particular application. Furthermore, steps or blocks in FIGS. 6 and 7 that recite a determining operation, or involve a decision, do not necessarily require that both branches of the determining operation be practiced. In other words, one of the branches of the determining operation can be deemed as an optional step.

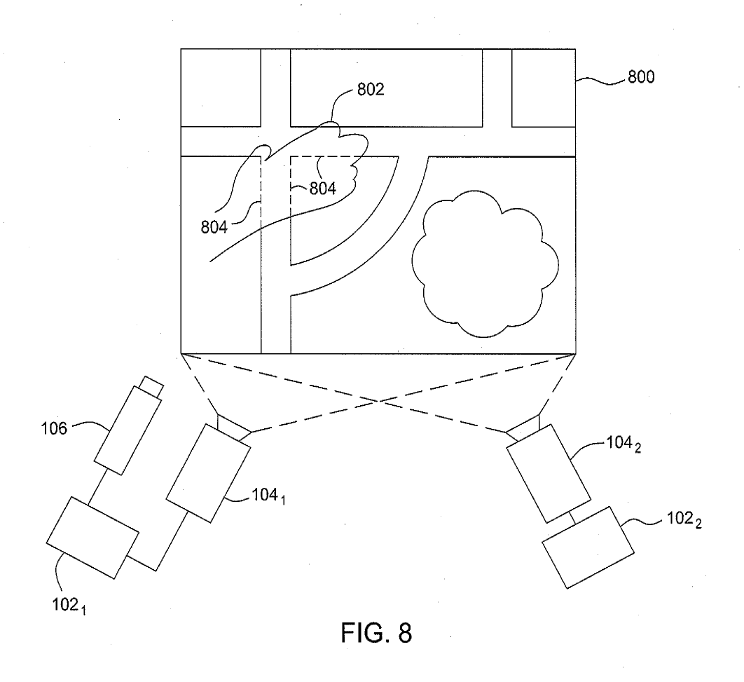

FIG. 8 displays another embodiment of the present disclosure that uses components from two systems 100 for interacting with projected displays. FIG. 8 illustrates a first system 100 that includes a projector 104₁, a camera 106 and a processing device 102₁ and a second system 100 that includes a projector 104₂ and a processing device 102₂. In one embodiment, both projectors 104₁ and 104₂ are projecting an identical image 800. In other words, the color, size, frame rate, etc of both images projected by the projectors 104₁ and 104₂ are identical.

In addition, the processing devices 102₁ and 102₂ are in communication with one another. The processing devices 102₁ and 102₂ may communicate via a wired connection (e.g., via a universal serial bus (USB) connection and the like) or a wireless connection (e.g., via a bluetooth connection, via a wireless local area network (WLAN), and the like). As a result, the images the processing devices 102₁ and 102₂ are displaying and projected by the projectors 104₁ and 104₂ are synchronized. That is, when a shadow gesture is detected that moves an image displayed by the processing device 102₁ and projected by the projector 104₁, the identical image displayed by the processing device 102₂ and projected by the projector 104₂ would also move in an identical fashion.

Typically, when a shadow 802 is used to generate a display formatting manipulation command, as discussed above, part of the projected image may be blocked due to the object creating the shadow being placed in front of the projector 104₁. However, by using two projectors 104₁ and 104₂, the second projector 104₂ may be used to maintain portions of the displayed images that would otherwise have been blocked by the object to create the shadow 802.

This is illustrated in FIG. 8 by portions 804 (shown in dashed lines) of the displayed images. For example, using only a single projector 104₁, portions 804 would normally have been blocked by the shadow 802. However, by using a second projector 104₂ that is projecting an identical image as projected by the projector 104₁, the image may be re-displayed on top of, over or around the shadow 802. As a result, no part of the image is lost while using shadows to generate display formatting manipulation commands. Moreover, as discussed above, because both processing devices 102₁ and 102₂ are synchronized, when the shadow 802 executes a command, e.g., pan left, both images projected by the projector 104₁ and 104₂ would pan left simultaneously in an identical fashion.

In yet another embodiment, both projectors 104₁ and 104₂ are projecting a “near” identical image 800. In other words, the image 800 does not have to be identical. For example, in one embodiment both images can be a map showing streets, but one map may provide street names while another may provide landmarks, e.g., building names, structure names etc. Thus, there is common or overlapping information, but the two images do not have to be 100% identical, where each image may be tasked with providing slightly different information in addition to the common information.

In yet another embodiment, when the shadow 802 is created, a portion of the image that would have been blocked is actually projected on to the object (e.g., a user's hand). In other words, the object becomes another surface for the projected display. Shadows may be used to interact with the image on the object to provide a finer grain interaction, as opposed to a more coarse grain interaction with the larger display 800. This may be advantageous when smaller features of the display 800 need to be manipulated using an object such as a stylus pen on the object creating the shadow 802, that would otherwise not be practical on the larger display 800.

FIG. 9 depicts a high-level block diagram of a general-purpose computer suitable for use in performing the functions described herein. In one embodiment, the general-purpose computer may be deployed as part of or in the mobile device 102 illustrated in FIG. 1. As depicted in FIG. 9, the system 900 comprises a processor element 902 (e.g., a CPU), a memory 904, e.g., random access memory (RAM) and/or read only memory (ROM), a module 905 for interacting with projected displays with shadows, and various input/output devices 906 (e.g., storage devices, including but not limited to, a tape drive, a floppy drive, a hard disk drive or a compact disk drive, a receiver, a transmitter, a speaker, a display, a speech synthesizer, a camera, a projecting device, an output port, and a user input device (such as a keyboard, a keypad, a mouse, and the like)).

It should be noted that the present disclosure can be implemented in software and/or in a combination of software and hardware, e.g., using application specific integrated circuits (ASIC), a general purpose computer or any other hardware equivalents. In one embodiment, the present module or process 905 for interacting with projected displays with shadows can be loaded into memory 904 and executed by processor 902 to implement the functions as discussed above. As such, the present method 905 for interacting with projected displays with shadows (including associated data structures) of the present disclosure can be stored on a non-transitory computer readable storage medium, e.g., RAM memory, magnetic or optical drive or diskette and the like.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method for interacting with a projected image using a shadow, comprising:
projecting an image of a processing device to create the projected image;
detecting a shadow on the projected image;
interpreting the shadow as a display formatting manipulation command; and
sending the display formatting manipulation command to an application of the processing device to manipulate a display format of the projected image.

2. The method of claim 1, wherein the processing device comprises a mobile device.

3. The method of claim 1, wherein the detecting the shadow is performed by a camera coupled to the processing device.

4. The method of claim 1, wherein the detecting the shadow comprises:
detecting outer edges of the projected image;
performing thresholding to determine which pixels of the projected image are shadow pixels; and
detecting an area of connected shadow pixels, where the area is greater than a predetermined threshold.

5. The method of claim 1, wherein the interpreting the shadow comprises:
tracking a shape of the shadow;
tracking a position vector of the shadow;
tracking a velocity vector of the shadow; and
tracking an acceleration vector of the shadow.

6. The method of claim 5, wherein the tracking the shape of the shadow, the tracking the position vector of the shadow, the tracking the velocity vector of the shadow and the tracking the acceleration vector of the shadow are performed continuously over a pre-defined time period.

7. The method of claim 1, wherein the display formatting manipulation command comprises at least one of: a pointing command, a panning command or a zooming command.

8. The method of claim 7, wherein the pointing command is correlated to the shadow having a convex hull that is separated by defects, wherein points on the convex hull that are separated by the defects are estimated as a location of a fingertip, wherein a location of the fingertip is stable for a predefined period of time.

9. The method of claim 8, wherein the pointing command causes a pop-up box with information about a selected point to appear on the projected image.

10. The method of claim 7, wherein the panning command is correlated to a centroid of the shadow having an average velocity over a predetermined time period above a predefined threshold in a direction.

11. The method of claim 10, wherein the direction is at least one of: an up direction, a down direction, a left direction or a right direction.

12. The method of claim 10, wherein the panning command causes the projected image to move in the direction of the shadow.

13. The method of claim 7, wherein the zooming command is correlated to at least one of: a change in an area of the shadow over a predetermined time period above a predefined threshold or detecting a transition of a number of fingertips.

14. The method of claim 13, wherein an increase in the change in the area of the shadow causes the projected image to zoom out and a decrease in the change in the area of the shadow causes the projected image to zoom in.

15. The method of claim 13, wherein the detecting the transition of the number of fingertips from a single fingertip to two fingertips causes the projected image to zoom out and detecting the transition from the two fingertips to the single fingertip causes the projected image to zoom in.

16. The method of claim 1, wherein the shadow is created by an object disposed in front of a projector.

17. The method of claim 1, wherein the projected image is displayed on a user's hand.

18. The method of claim 1, further comprising:
projected a second display of a second processing device to create a second projected image, wherein the second projected image overlaps the projected image such that a portion of the projected image blocked by the shadow is re-displayed on top of the shadow via the second projected image.

19. A computer-readable medium having stored thereon a plurality of instructions, the plurality of instructions including instructions which, when executed by a processor, cause the processor to perform a method for interacting with a projected image using a shadow, comprising:
projecting an image of a processing device to create the projected image;
detecting a shadow on the projected image;
interpreting the shadow as a display formatting manipulation command; and
sending the display formatting manipulation command to an application of the processing device to manipulate a display format of the projected image.

20. An apparatus for interacting with a projected image using a shadow, comprising:
means for projecting an image of a processing device to create the projected image;
means for detecting a shadow on the projected image;
means for interpreting the shadow as a display formatting manipulation command; and
means for sending the display formatting manipulation command to an application of the processing device to manipulate a display format of the projected image.
